(19) United States
(12) Patent Application Publication
(10) Pub. No.: US 2011/0232145 A1
(43) Pub. Date: Sep. 29, 2011

(54) MYEZ2C

(76) Inventor: Joseph Fleming, Teaneck, NJ (US)

(21) Appl. No.: 12/661,860

(22) Filed: Mar. 25, 2010

(51) Int. Cl. G09F 3/18

(52) U.S. Cl. 40/644

(57) ABSTRACT

The Invention is a plastic 3½″×3½″×¼″ open sided sleeve with Velcro adhesive on the front of the open side which will adhere to the inside of the windshield of an automobile, creating a pocket into which parking receipts for Muni-meters can be placed for viewing and for storage.

A flexible plastic holder, designed to adhere to the windshield of a motor vehicle to permit the insertion, storage, and removal of paper parking receipts.

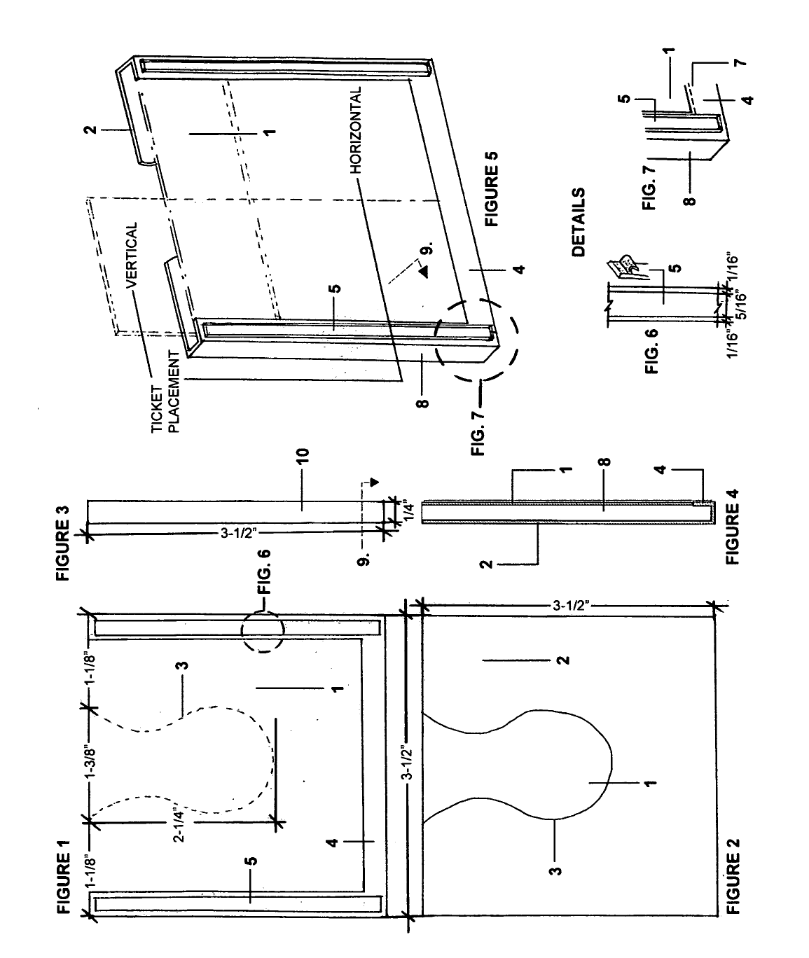

FIG. 1 is a plain view of the front of the ticket holder;

FIG. 2 is a plain view of the backside of the ticket holder;

FIG. 3 is an elevation view of the bottom of the ticket holder;

FIG. 4 is a cross sectional view, not cut directly down the middle of the ticket holder;

FIG. 5 is an axonometric view, illustrating horizontal and vertical ticket placement;

FIG. 6 is a detailed view of the Velcro attachment which connects to the window shield;

FIG. 7 is a detailed view of the bottom corner of the ticket holder, illustrating the stitched connection between the flexible plastic frame and the clear plastic covering;

1. The Invention is a unique product designed to accommodate the growing use of muni-meters in metropolitan areas throughout the country.
Muni-meters dispense parking receipts, which are then placed on the dashboard of the motor vehicle. These parking receipts have a tendency to blow away or otherwise become out of place. The Invention creates a receptacle for the parking receipt, holding it firmly in place against the windshield, allowing it to be easily seen and read by Parking Attendants or Police.
The Invention also permits multiple receipts to be stored, allowing the vehicle's Owner to retain parking receipts in one convenient location for record purposes.
There are no existing inventions or products designed or utilized to address the need identified. The design of the Invention includes a flexible plastic casing, which adheres to the windshield with a reverse side cut out which allows the parking receipt to be inserted and removed easily with the thumb or finger.
The Invention is unique and of great value, at a time when the vast majority of parking meters are being converted to muni-meters.
